(19) United States
(12) Patent Application Publication
(10) Pub. No.: US 2009/0086796 A1
(43) Pub. Date: Apr. 2, 2009

(54) Method And System For A High Frequency Signal Repeater Using A DDFS

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/864,854

(22) Filed: Sep. 28, 2007

(51) Int. Cl. H04B 1/38

(52) U.S. Cl. 375/219

(57) ABSTRACT

Certain embodiments of the invention may be found in a method and system for a high frequency signal repeater using DDFS. Aspects of the method may comprise generating a first signal via a direct digital frequency synthesizer (DDFS), frequency translating a received RF signal using the first signal, and transmitting the frequency translated RF signal. The DDFS may generate the first signal using, for example, a local oscillator signal as a reference clock. A processor, which may comprise a CPU and/or hardware circuitry, may communicate one or more frequency control words to the DDFS to control generation of the first signal. Various embodiments of the invention may comprise mixing the first signal and the received RF signal via one or more mixers to generate the frequency translated RF signal.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### [MICROFICHE/COPYRIGHT REFERENCE]

[Not Applicable]

### FIELD OF THE INVENTION

Certain embodiments of the invention relate to wireless communication. More specifically, certain embodiments of the invention relate to a method and system for a high frequency signal repeater using a direct digital frequency synthesizer (DDFS).

### BACKGROUND OF THE INVENTION

Wireless communication has become pervasive throughout our modern society, leading to crowding of allocated communication spectrums. Accordingly, new communication spectrums are being allocated and used for ever increasing applications. However, since higher frequency signals tend to transmit to line-of-sight receivers, repeaters may be necessary to communicate between two wireless devices that are separated by a barrier. Additionally, repeaters may be necessary to communicate between devices that may be too far from each other for direct transmission.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for a high frequency signal repeater using a DDFS, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, in accordance with an embodiment of the invention.

FIG. 2A is a block diagram illustrating a repeater device utilized to forward EHF communication, in accordance with an embodiment of the invention.

FIG. 2B is a block diagram illustrating a portion of an exemplary RF front end for a repeater, in accordance with an embodiment of the invention.

FIG. 3A is a block diagram of an exemplary repeater using a DDFS, in accordance with an embodiment of the invention.

FIG. 3B is a block diagram of an exemplary repeater using a phase shifter signals to mix with signals from a DDFS, in accordance with an embodiment of the invention.

FIG. 3C is a block diagram of an exemplary repeater using a phase shifter after mixing with signals from a DDFS, in accordance with an embodiment of the invention.

FIG. 4 is a block diagram illustrating an exemplary direct digital frequency synthesizer, in accordance with an embodiment of the invention.

FIG. 5 is a flow diagram illustrating exemplary steps for using a DDFS in a repeater for EHF, in accordance with an embodiment of the invention.

### DETAILED DESCRIPTION OF THE INVENTION

Certain embodiments of the invention may be found in a method and system for a high frequency signal repeater using DDFS. Aspects of the method may comprise generating a first signal via a direct digital frequency synthesizer (DDFS), frequency translating a received RF signal using the first signal, and transmitting the frequency translated RF signal. The DDFS may generate the first signal using, for example, a local oscillator signal as a reference clock. A processor, which may comprise a CPU and/or hardware circuitry, may communicate one or more frequency control words to the DDFS to control generation of the first signal.

An embodiment of the invention may comprise mixing the first signal and the received RF signal to generate the frequency translated RF signal, which may comprise a lower sideband and an upper sideband. The frequency translated RF signal may be bandpass filtered to select either the upper sideband or the lower sideband for transmission. Other embodiments of the invention may comprise utilizing a phase shifter, a DDFS, and a plurality of mixers. The outputs of the mixers may be combined together to generate a frequency translated RF signal that may comprise either a lower sideband or an upper sideband. By appropriately controlling inverting of a signal used by one of the mixers, either the lower sideband or the upper sideband may be selected for the frequency translated RF signal. Configuring and/or controlling various circuitry to select a sideband for the frequency translated RF signal may be via a processor.

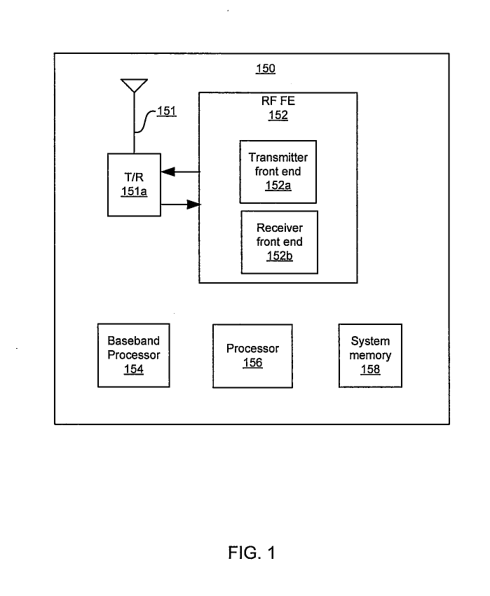

FIG. 1 is a block diagram of an exemplary wireless system, in accordance with an embodiment of the invention. Referring to FIG. 1, the wireless system 150 may comprise an antenna 151, a transmitter/receiver switch 151a, a RF front end (RFFE) 152 comprising a transmitter front end 152a, a receiver front end 152b, a baseband processor 154, a processor 156, and a system memory 158. The transmitter/receiver switch 151a may comprise suitable circuitry that enables the antenna 151 to be used for both receiving and transmitting. The transmitter front end (TFE) 152a may generally comprise suitable logic, circuitry, and/or code that may be adapted to up-convert a baseband signal directly to an RF signal and to transmit the RF signal via the antenna 151. The TFE 152a may also be adapted to up-convert a baseband signal to an IF signal, and/or up-convert the IF signal to a RF signal and then transmit the RF signal via the antenna 151. The TFE 152a may be adapted to execute other functions, for example, filtering the baseband signal, and/or amplifying the baseband signal.

The receiver front end (RFE) 152b may generally comprise suitable logic, circuitry, and/or code that may be adapted to down-convert a RF signal directly to a baseband signal for further processing. The RFE 152b may also be adapted to down-convert a RF signal to an IF signal, and/or down-convert the IF signal to a baseband signal for further processing. The RFE 152b may be adapted to execute other functions, for example, filtering the baseband signal, and/or amplifying the baseband signal.

The baseband processor 154 may comprise suitable logic, circuitry, and/or code that may be adapted to process baseband signals, for example, convert a digital signal to an analog signal, and/or vice-versa. The processor 156 may be a suitable processor or controller such as a CPU or DSP, or any type of integrated circuit processor. The processor 156 may comprise suitable logic, circuitry, and/or code that may be adapted to control the operations of the TFE 152a and/or the baseband processor 154. For example, the processor 156 may be utilized to update and/or modify programmable parameters and/or values in a plurality of components, devices, and/or processing elements in the TFE 152a and/or the baseband processor 154. Furthermore, if the wireless system 150 comprises more than one processor, control and/or data information, which may include the programmable parameters, may be transferred from at least one controller and/or processor to the processor 156. Similarly, the processor 156 may be adapted to transfer control and/or data information, which may include the programmable parameters, to at least one controller and/or processor, which may be part of the wireless system 150. The baseband processor 154 and/or the processor 156 may also be enabled to control, for example, a bandpass filter to select a desired passband spectrum.

The processor 156 may utilize the received control and/or data information, which may comprise the programmable parameters, to determine an operating mode of the TFE 152a. For example, the processor 156 may be utilized to select a specific frequency for a local oscillator generator, or a specific gain for a variable gain amplifier. Moreover, the specific frequency selected and/or parameters needed to calculate the specific frequency, and/or the specific gain value and/or the parameters needed to calculate the specific gain, may be stored in the system memory 158 via the processor 156. The information stored in system memory 158 may be transferred to the TFE 152a from the system memory 158 via the processor 156. The system memory 158 may comprise suitable logic, circuitry, and/or code that may be adapted to store a plurality of control and/or data information, including parameters needed to calculate frequencies and/or gain, and/or the frequency value and/or gain value.

While a general RFFE 152 comprising the TFE 152a and the RFE 152b may have been described, other embodiments of the invention may comprise a RFFE 152 that may be used for repeating signals. For example, the RFFE 152 may receive signals, including signals transmitted in the extremely high frequency (EHF) band. The RFFE 152 may amplify and/or filter the received signal, and then mix the received to a different RF frequency, which may also be, for example, in the EHF band. The signal may be further amplified by the RFFE 152 to a signal strength appropriate for transmission. The amplified signal may then be transmitted, for example, via the antenna 151. Accordingly, the antenna 151 may comprise a transmit antenna and a receive antenna that may be used for simultaneous reception and transmission.

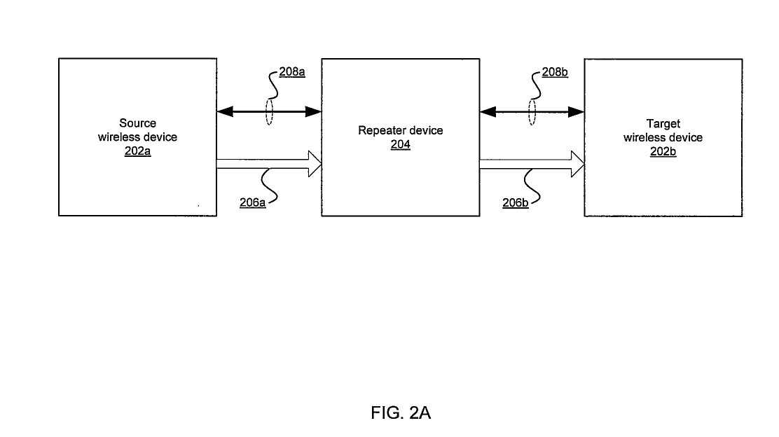

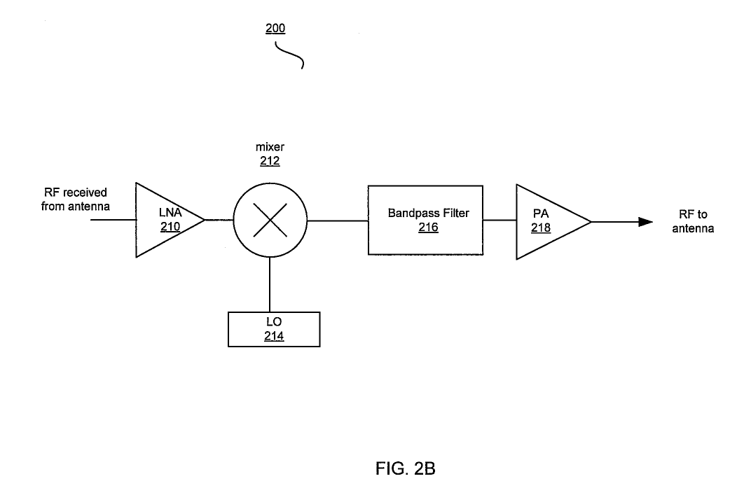

FIG. 2A is a block diagram illustrating a repeater device utilized to forward EHF communication, in accordance with an embodiment of the invention. Referring to FIG. 2A, there is shown a source wireless device 202a, a target wireless device 202b, a repeater device 204, EHF connections 206a and 206b, and control connections 208a and 208b.

The source wireless device 202a and the target wireless device 202b may each comprise suitable logic, circuitry, and/or code that may enable receiving, transmitting, and processing of RF signals. For example, the source wireless device 202a and the target wireless device 202b may each comprise the wireless system 150, substantially as described in FIG. 1.

The repeater device 204 may comprise suitable logic, circuitry, and/or code that may enable reception and/or transmission of EHF signals to facilitate forwarding EHF signals from the source wireless device 202a to the target wireless device 202b. Additionally, the repeater device 204 may comprise suitable logic, circuitry, and/or code that may enable establishing and/or utilizing control connections 208a and 208b with the source wireless device 202a and/or target wireless device 202b, respectively.

The EHF connections 206a and 206b may each transmit and receive signals, including signals with frequencies, for example, in the EHF band. The control connections 208a and 208b may communicate control messages between the source wireless device 202a and the repeater device 204, and between the repeater device 204 and the target device 202b, respectively.

In operation, the repeater device 204 may enable forwarding EHF RF signals transmitted from the source wireless device 202a via the EHF connection 206a, to the target wireless device 202b via the EHF connection 206b. The wireless device 202a may utilize the wireless system 150 to enable transmission of EHF RF signals via the EHF connection 206a. The wireless device 202b may utilize the wireless system 150 to enable reception of EHF RF signals via the EHF connection 206b. The repeater device 204 may be utilized because EHF RF signals may have limited operational range. The source wireless device 202a, the target wireless device 202b, and/or the repeater device 204 may utilize the control connections 208a and/or 208b during EHF communication between the three devices. The control connections 208a and/or 208b may enable exchanging control messages, data, and/or information that may enable facilitating EHF communication. For example, the control connection 208a and/or 208b may enable the repeater device 204 to receive and/or transmit control messages that may enable the source wireless device 202a to transmit EHF RF signals to the repeater device 204 via the EHF connection 206a, and/or may enable the target wireless device 202b to receive EHF RF signals from the repeater device 204 via the EHF connection 206b.

FIG. 2B is a block diagram illustrating a portion of an exemplary RF front end for a repeater, in accordance with an embodiment of the invention. Referring to FIG. 2B, there is shown an exemplary RF front end (RFFE) 200 comprising amplifiers 210 and 218, a mixer 212, a local oscillator (LO) generator 214, and a bandpass filter 216. The amplifiers 210 and 218 may comprise suitable logic, circuitry, and/or code that may be enabled to amplify input signals and output the amplified signals. Accordingly, each of the amplifiers 210 and 218 may comprise a fixed gain amplifier or a variable gain amplifier. The amplifier 210 may be a low noise amplifier (LNA) that may be utilized in instances where the signal to noise ratio (SNR) may be relatively low, such as, for example, RF signals received by an antenna. The amplifier 218 may be a power amplifier that may be enabled to provide sufficient gain for a signal that may be transmitted.

The mixer 212 may comprise suitable logic, circuitry, and/or code that may be adapted to receive two input signals, and generate at least one output signal, where the output signal may comprise frequencies that may be a difference of the frequencies of the two input signals and a sum of the frequencies of the two input signals.

The LO generator 214 may comprise suitable logic, circuitry, and/or code that may be adapted to output a signal of a specific frequency. The bandpass filter 216 may comprise suitable logic, circuitry, and/or code that may be adapted to selectively pass signals within a certain bandwidth while attenuating signals outside that bandwidth.

In operation, the RF signal, which may have a carrier frequency referred to as f_{RF}, may be received by an antenna and communicated to the amplifier 210, where the RF signal may be amplified. The amplified RF signal may be communicated to an input of the mixer 212. The output signal of the LO generator 214, which may have a frequency f_{LO}, may be communicated to another input of the mixer 212. The mixer 212 may process the two input signals such that the output signal may have a desired frequency, which may comprise, for example, a frequency of either (f_{RF}−f_{LO}) or (f_{RF}+f_{LO}). The mixer 212 output signal may be referred to as an transmit RF signal.

The transmit RF signal may be communicated to a bandpass filter 216, which may be adapted to pass the desired bandwidth of signals about the transmit RF frequency, while attenuating the undesired frequencies in the transmit RF signal. The filtered transmit RF signal may be amplified by the amplifier 218, and the amplified transmit RF signal may be communicated to the antenna 151 for transmission.

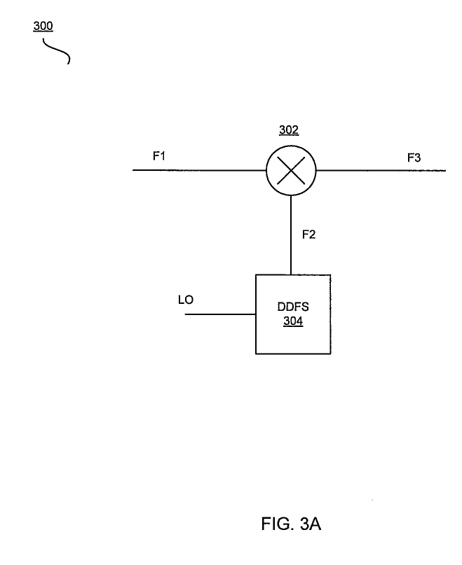

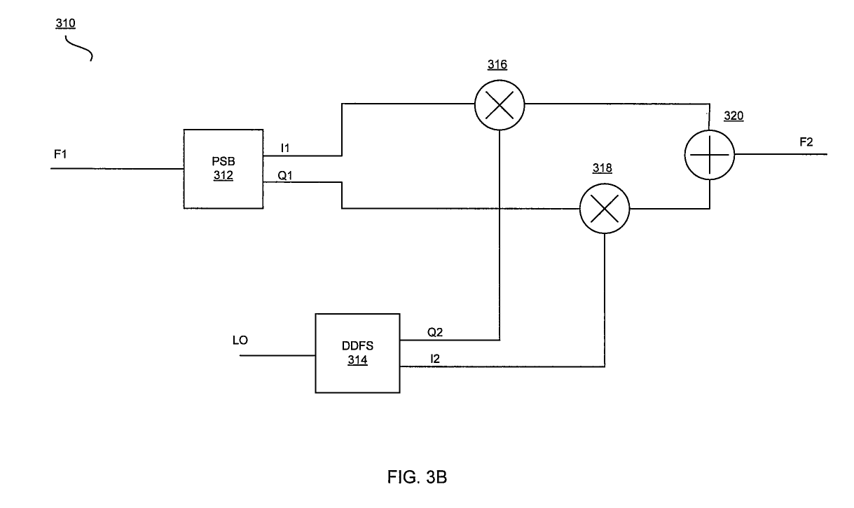

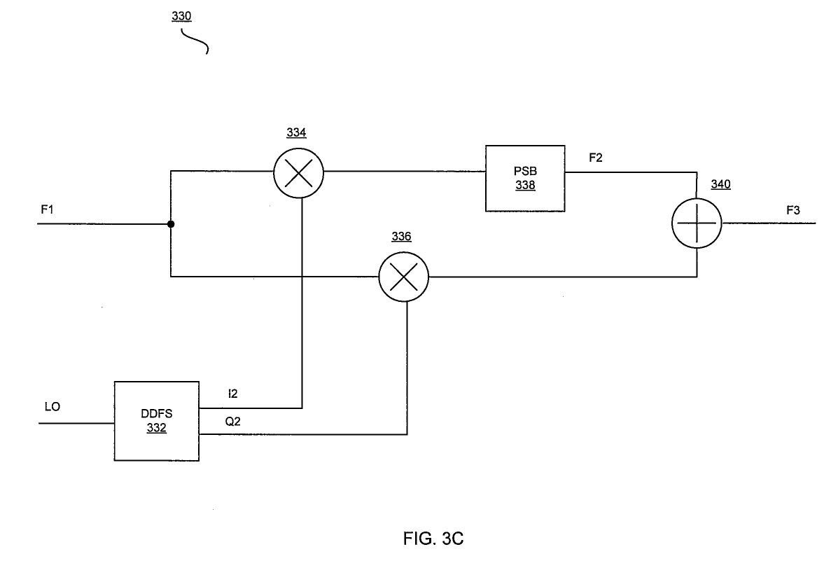

FIG. 3A is a block diagram of an exemplary repeater using a DDFS, in accordance with an embodiment of the invention. Referring to FIG. 3A, there is shown a frequency translation circuit 300 comprising a mixer 302 and a direct digital frequency synthesizer (DDFS) 304. The frequency translation circuit 300 may receive signals modulated about a carrier frequency and generate output RF signals that may be modulated about a different carrier frequency. The information in the received RF signals may be the same as the information in the output RF signals. The frequency translation circuit 300 may be utilized, for example, for repeaters such as the repeater device 204.

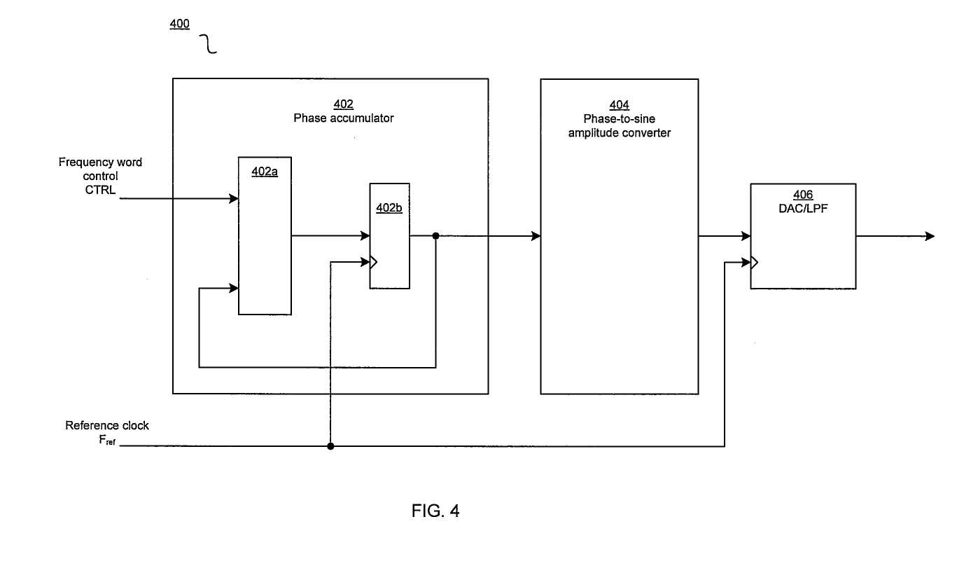

The mixer 302 may be similar to the mixer 212. The DDFS 304 may comprise suitable logic, circuitry, and/or code that may be enable generation of at least one signal at a particular frequency, where the frequency may be variable. Operation of an exemplary DDFS is disclosed with respect to FIG. 4.

In operation, an input RF signal F1, which may comprise, for example, a carrier frequency that may be in the EHF band, may be communicated to the mixer 302. The mixer 302 may also receive a signal F2 from the DDFS 304. The DDFS 304 may generate the signal F2 using the LO signal F_{LO} generated by, for example, the LO generator 214. The mixer may generate, for example, an output signal F3 that may be modulated about a carrier frequency that may be a sum of the frequency of the RF signal F1 and a frequency of the signal F2 generated by the DDFS 304. The output signal F3 may also comprise signals that may be modulated, for example, about a carrier frequency that may be a difference of the frequency of the RF signal F1 and a frequency of the signal F2 generated by the DDFS 304.

The signal F3 may be filtered, for example, by the bandpass filter 216. The bandpass filter 216 may filter the signal F3 appropriately to output signals that may comprise either the upper sideband or the lower sideband. For example, the bandpass filter 216 may be controlled by a processor such as, for example, the baseband processor 154 and/or the processor 156, to select a desired passband spectrum. The specific method of controlling the bandpass filter 216 to select either the upper sideband or the lower sideband may be design dependent.

FIG. 3B is a block diagram of an exemplary repeater using a phase shifter signals to mix with signals from a DDFS, in accordance with an embodiment of the invention. Referring to FIG. 3B, there is shown a frequency translation circuit 310 comprising a phase shifter block 312, a DDFS 314, mixers, 316 and 318, and a signal combiner 320. The phase shifter block 312 may comprise suitable logic and/or circuitry that may enable receiving an input signal and generating two output signals where the two output signals may be, for example, 90° out of phase with respect to each other. The DDFS 314 may be similar to the DDFS 304, and the mixers 316 and 318 may be similar to the mixer 302. The signal combiner 320 may comprise circuitry that may allow combining signals. For example, the signal combiner 320 may comprise wire-ORing when the signals to be combined are currents. Since the mixers 316 and 318 may output current signals, the outputs of the mixers 316 and 318 may be directly electrically connected together to combine the currents output by the mixers 316 and 318.

In operation, the input RF signal F1, which may comprise, for example, a carrier frequency that may be in the EHF band, may be communicated to the phase shifter block 312. The phase shifter block 312 may generate an in-phase component I1 and a quadrature phase component Q1. The components I1 and Q1 may be communicated to the mixers 316 and 318, respectively. The DDFS 314 may receive a local oscillator signal and may output a signal that comprises an in-phase component I2 and a quadrature phase component Q2. The in-phase component I2 may be communicated to the mixer 318, and the quadrature phase component Q2 may be communicated to the mixer 316.

The I1 and I2 components may be represented as, for example, sin(A) and sin(B), and the Q1 and Q2 components may be represented as, for example, cos(A) and cos(B). Accordingly, the mixer 316 may multiply the components I1 and Q2 to result in an output signal I1*Q2 that may be expressed as sin(A)cos(B). By using a trigonometric identity, sin(A)cos(B) may be represented as ½[sin(A+B)+sin(A−B)]. Similarly, the mixer 318 may multiply the components I2 and Q1 to result in an output signal I2*Q1 that may be expressed as cos(A)sin(B). By using a trigonometric identity, cos(A)sin(B) may be expressed as ½[sin(A+B)−sin(A−B)]. The outputs of the mixers 316 and 318 may be combined by the signal combiner 320, and the result may be an output RF signal F2 that may be expressed as:

$$\begin{matrix}F 2 = 1 / 2 [ \begin{matrix}sin ( A + B ) + \\ sin ( A - B )\end{matrix} ] + 1 / 2 [ \begin{matrix}sin ( A + B ) - \\ sin ( A - B )\end{matrix} ] \\ = sin ( A + B ) .\end{matrix} \qquad [ 1 ]$$

This may be referred to as an upper sideband.

When the signal combiner 320 performs a subtraction, then the output RF signal F2 may be expressed as:

$$\begin{matrix}F 2 = 1 / 2 [ \begin{matrix}sin ( A + B ) + \\ sin ( A - B )\end{matrix} ] - 1 / 2 [ \begin{matrix}sin ( A + B ) - \\ sin ( A - B )\end{matrix} ] \\ = sin ( A - B ) .\end{matrix} \qquad [ 2 ]$$

This may be referred to as a lower sideband.

Accordingly, by appropriately inverting or not inverting the signal I2*Q1, the signal combiner 320 may translate the input RF signal F1 to an output RF signal F2, where the signal F2 may comprise an upper sideband or a lower sideband. An output signal may be inverted with respect to an input signal when, for example, there is a phase difference of 180° between the output signal and the input signal. Whether the signal I2*Q1 may be inverted may be controlled, for example, by the baseband processor 154 and/or the processor 156. Inverting a signal may comprise, for example, a phase shift of 180° with respect to the original signal that is being inverted.

Therefore, an embodiment of the invention may generate the output RF signal F2 as an upper sideband or a lower sideband. The baseband processor 154 and/or the processor 156 may configure the DDFS 314 to determine the frequency of the signal generated by the DDFS 314, and also control whether the output of the signal combiner 320 is an upper sideband or lower sideband. The specific method of controlling of inverting the signal I2*Q1 may be design dependent.

FIG. 3C is a block diagram of an exemplary repeater using a phase shifter after mixing with signals from a DDFS, in accordance with an embodiment of the invention. Referring to FIG. 3C, there is shown a frequency translation circuit 330 comprising a DDFS 332, mixers 334 and 336, a phase shifter block 338, and a signal combiner 340. The DDFS 332, the mixers 334 and 336, and the signal combiner 340 may be similar to the corresponding circuitry shown with respect to FIG. 3B. The phase shifter block 338 may be similar in functionality to the phase shifter block 312. However, the phase shifter block 338 may receive an input signal and generate an output signal that may be phase shifted with respect to the input signal.

In operation, the input RF signal F1, which may comprise, for example, a carrier frequency that may be in the EHF band, may be communicated to the mixers 334 and 336. The DDFS 314 may receive a local oscillator signal and may output a signal that comprises an in-phase component I2 and a quadrature phase component Q2. The in-phase component I2 may be communicated to the mixer 334, and the quadrature phase component Q2 may be communicated to the mixer 336.

The signal F1 may be described, for example, as sin(A). Similarly, the components I2 and Q2 may be described as, for example, sin(B) and cos(B), respectively. Accordingly, the mixer 334 may multiply the components F1 and I2 to result in an output signal F1*I2 that may be expressed as sin(A)sin(B). By using a trigonometric identity, sin(A)sin(B) may be expressed as −½[cos(A+B)−cos(A−B)]. The output of the mixer 334 may be communicated to the phase shifter block 338. The phase shifter block 338 may generate an output signal F2 that may be substantially 90° out of phase with respect to the input signal. Accordingly, the output signal F2 may be expressed as −½[sin(A+B)−sin(A−B)]. The output signal F2 may be communicated to the signal combiner 340.

The mixer 336 may multiply the components F1 and Q2 to result in an output signal F1*Q2 that may be expressed as sin(A)cos(B). By using a trigonometric identity, sin(A)cos(B) may be expressed as ½[sin(A+B)+sin(A−B)]. The output of the mixer 336 may be communicated to the signal combiner 340. The signal combiner 340 may combine, or add, the signals from the phase shifter block 338 and the mixer 336, and the result may be an output RF signal F3 that may be expressed as:

$$\begin{matrix}F 3 = \{ - 1 / 2 [ \begin{matrix}sin ( A + B ) - \\ sin ( A - B )\end{matrix} ] \} + 1 / 2 [ \begin{matrix}sin ( A + B ) + \\ sin ( A - B )\end{matrix} ] \\ = sin ( A - B ) .\end{matrix} \qquad [ 3 ]$$

This may be a lower sideband.

When the signal combiner 340 combines an inverted version of the phase shifted signal F2 with the signal F11*Q2, then the output RF signal F3 may be expressed as:

$$\begin{matrix}F 3 = - \{ - 1 / 2 [ \begin{matrix}sin ( A + B ) - \\ sin ( A - B )\end{matrix} ] \} + 1 / 2 [ \begin{matrix}sin ( A + B ) + \\ sin ( A - B )\end{matrix} ] \\ = sin ( A + B ) .\end{matrix} \qquad [ 4 ]$$

This may be an upper sideband.

Accordingly, by appropriately inverting or not inverting the signal F1*I2, the signal combiner 340 may translate the input RF signal F1 to an output RF signal F3, where the signal F3 may comprise an upper sideband or a lower sideband. The signal F1*I2 may be inverted, for example, by the mixer 334, the phase shifter block 338, or the signal combiner 340. An output signal may be inverted with respect to an input signal when, for example, there is a phase difference of 180° between the output signal and the input signal. Whether the signal F1*I2 may be inverted may be controlled, for example, by the baseband processor 154 and/or the processor 156.

Therefore, an embodiment of the invention may generate the output RF signal F3 as an upper sideband or a lower sideband. The baseband processor 154 and/or the processor 156 may configure the DDFS 332 to determine the frequency of the signal generated by the DDFS 332, and also control whether the output of the signal combiner 340 is an upper sideband or lower sideband. The specific method of configuring the DDFS 332 and controlling inverting of the signal F1*I2 may be design dependent

FIG. 4 is a block diagram illustrating an exemplary direct digital frequency synthesizer, in accordance with an embodiment of the invention. Referring to FIG. 4, there is shown a direct digital frequency synthesizer (DDFS) 400 comprising a phase accumulator 402, a phase-to-sine amplitude converter 404, and a digital to analog converter (DAC) 406. The DDFS 400 may be similar in functionality to the DDFS 306. The phase accumulator 402 may comprise an adder 402a that may enable integrating an input signal, such as, for example, a frequency control word CTRL, by adding it to a previous integrated value stored in a register 402b on each cycle of a reference clock F_{ref}. The frequency control word CTRL may be provided by, for example, the processor 156 and/or the baseband processor 154. Various embodiments of the invention may also comprise a control word block (not shown) that may be used to provide the control word. The reference clock F_{ref} may be communicated by, for example, the divider block 304. The reference clock F_{ref} may be fixed-frequency or varying frequency. In the case of a varying reference clock F_{ref}, the change in frequency may be compensated by altering the frequency control word CTRL such that the output of the DDFS may comprise a desired frequency and/or phase.

The phase-to-sine amplitude converter 404 may comprise suitable logic, circuitry, and/or code that may enable converting the output of the phase accumulator 402 to an approximated sine amplitude. For example, the conversion may be achieved via a look-up table. Although only a single output may be shown for exemplary purposes, a plurality of signals may be generated where each signal may be phase shifted from the others. For example, where I and Q signals may be needed, the phase-to-sine amplitude converter 404 may utilize a plurality of different look-up tables for each input value. In an exemplary embodiment of the invention, a first look-up table may be utilized for the I signal and a second look-up table may be utilized for the Q signal.

The DAC 406 may comprise suitable logic and/or circuitry that may enable converting the digital output of the phase-to-sine amplitude converter 404 to an analog output. The DAC 406 may also comprise, for example, a low-pass filter that may be used to “smooth” the analog output. Where the DDFS 400 may generate, for example, I and Q signals, there may be a DAC for generating an I signal and a DAC for generating a Q signal. Accordingly, the DDFS 400 may be a digitally-controlled signal generator that may vary phase, frequency, and/or amplitude of one or more output signals based on a single reference clock F_{ref} and a frequency control word CTRL.

In operation, the frequency control word CTRL may be provided to the adder 402a, and may be successively added to an integrated value stored in the register 402b. The adding may occur, for example, on each cycle of the reference clock F_{ref}. In this manner, the sum may eventually be greater than the maximum value the accumulator can store, and the value in the accumulator may overflow or “wrap”. Accordingly, an N-bit phase accumulator 402 may overflow at a frequency Fₒᵤₜ given by the following equation:

Fₒᵤₜ=(F_{ref}*CTRL)/2^{N} [2]

In this manner, the output of the phase accumulator 402, which may be referred to as Fₒᵤₜ, may be periodic at a period of 1/Fₒᵤₜ and may represent the phase angle of a signal. In this regard, the DDFS 422 may operate as a frequency generator that generates one or more sine waves or other periodic waveforms over a large range of frequencies, from almost DC to approximately half the reference clock frequency F_{ref}.

Prior to changing the frequency control word CTRL, the state of the DDFS 400 may be saved in, for example, a memory such as the system memory 158. In this manner, the output signal Fₒᵤₜ may be interrupted and then resumed without losing the phase information comprising the generated signals. For example, the DDFS 400 may resume generating the output signal Fₒᵤₜ using the saved state loaded from, for example, the system memory 158. Accordingly, the output signal Fₒᵤₜ may resume from the last phase angle transmitted before the signal was interrupted.

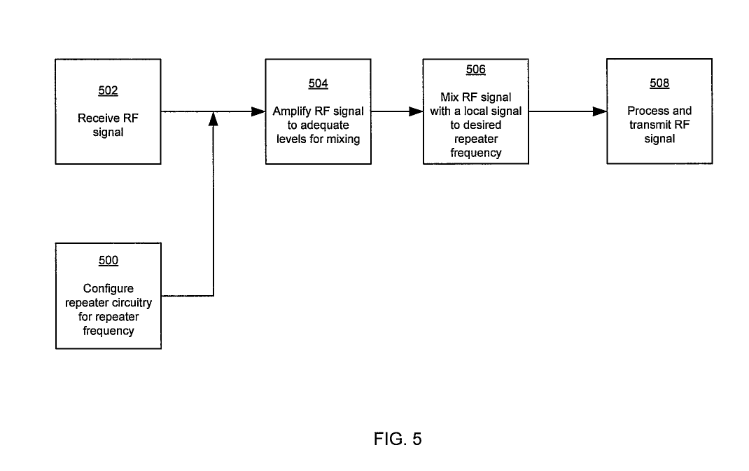

FIG. 5 is a flow diagram illustrating exemplary steps for using a high frequency signal repeater using DDFS, in accordance with an embodiment of the invention. Referring to FIG. 5, there is shown steps 500 to 508. In step 500, the repeater device 204 may be configured for a receive frequency and/or a transmit frequency. For example, the amplifiers 210 and/or 328 may be variable gain amplifiers that may be set for an appropriate gain. The bandpass filter 216 may also be configured appropriately to select either the upper sideband or the lower sideband of the signal output by the mixer 302. Also, the DDFS 304, 314, or 332 may be configured to generate an appropriate frequency, and the frequency translation circuit 310 and/or 330 may be configured to generate either the upper sideband or the lower sideband output by the signal combiners 320 and 340, respectively.

In step 502, the repeater device 204 may receive RF signals. The RF signals may have been transmitted by, for example, the source wireless device 202a. In step 504, the received RF signal may be amplified appropriately by, for example, the amplifier 210 so that the signal strength may be adequate for further processing. For example, the amplified RF signal may be mixed by the mixer 302, or the mixers 334 and 336, or phase shifted by the phase shifter block 312.

In step 506, the amplified RF signal may be frequency translated to an output RF frequency. The frequency translation may be via, for example, one of the exemplary frequency translators 300, 310, and 330. Whether an upper sideband signal or a lower sideband signal may be used for transmission may be controlled by, for example, the processor 156 and/or the processor 154. For example, when the frequency translator 300 is used, the processor 156 and/or the processor 154 may control the bandpass filter 216 to select an appropriate sideband. When the frequency translator 310 or 330 is used, the processor 156 and/or the processor 154 may control inverting of signals in the frequency translator to determine which sideband is output.

In step 508, the frequency translated RF signal may be processed and transmitted. Processing may comprise, for example, filtering and/or amplifying by the RFFE 200 to an appropriate power level for transmission. Accordingly, the target wireless device 202b may be able to receive information originally transmitted by the source wireless device 202a.

In accordance with an embodiment of the invention, aspects of an exemplary system may comprise the RFFE 200 that may frequency translate a received RF signal, for example, from the amplifier 210. The frequency translation may be performed utilizing a direct digital frequency synthesizer (DDFS), such as the DDFS 304, 314, and/or 332. The DDFS 304, 314, and/or 332 may utilize, for example, a local oscillator signal as a reference clock, to generate a first clock. The frequency translated signal may be further processed, for example, filtering and/or amplifying by the RFFE 200, and then transmitted, for example, by the antenna 151. The DDFS 304, 314, and/or 332 may be communicated one or more frequency control words by the processor 156 and/or the baseband processor 154 to control generation of the first signal.

An embodiment of the invention may comprise the frequency translation circuit 300 that may enable mixing, via the mixer 302, the first signal generate by the DDFS 304 and the received RF signal to generate the frequency translated RF signal. The frequency translated RF signal may comprise a lower sideband and an upper sideband. The output of the mixer 302 may be filtered, for example, by the bandpass filter 216, to select either the lower sideband or the upper sideband. Selection of a sideband may be controlled, for example, by the processor 156 and/or the baseband processor 154.

Another embodiment of the invention may comprise the frequency translation circuit 310 that may enable the DDFS 314 to generate the first signal that may comprise an in-phase (I) component and a quadrature (Q) component. The phase shifter block 312 may phase shift the received RF signal to generate in-phase (I) and quadrature components (Q) of the received RF signal. The mixer 316 may mix the I component of the received RF signal with the Q component of the first signal, and the mixer 318 may mix the Q component of the received RF signal with the I component of the first signal. The outputs of the mixers 316 and 318 may be combined by the signal combiner 320 to generate the frequency translated RF signal F2. The frequency translated RF signal may comprise either an upper sideband or a lower sideband. The processor 156 and/or the baseband processor 154 may control inverting or not inverting of a signal output by the mixer 316 to select a lower sideband or an upper sideband for transmission.

Another embodiment of the invention may comprise the frequency translation circuit 330 that may enable the DDFS 332 to generate the first signal that may comprise an in-phase (I) component and a quadrature (Q) component. The received RF signal may be communicated to the mixers 334 and 336. The mixer 334 may mix the received RF signal with the I component of the first signal, and the mixer 336 may mix the received RF signal with the Q component of the first signal. The output of the mixer 334 may be communicated to the phase shifter block 338, which may generate a signal F2 that may be substantially 90° out of phase with the input signal. The signal F2 may be combined with the output of the mixer 336 to generate the frequency translated RF signal F3, which may comprise either a lower sideband or an upper sideband. The processor 156 and/or the baseband processor 154 may control inverting or not inverting of a signal output by the mixer 334 to select an upper sideband or a lower sideband for transmission.

Another embodiment of the invention may provide a machine-readable storage, having stored thereon, a computer program having at least one code section executable by a machine, thereby causing the machine to perform the steps as described above for a high frequency signal repeater using DDFS.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for wireless communication, the method comprising:
generating a first signal via a direct digital frequency synthesizer (DDFS);
frequency translating a received RF signal using said first signal; and
transmitting said frequency translated RF signal.

2. The method according to claim 1, wherein said first signal is generated based on a local oscillator signal.

3. The method according to claim 1, comprising communicating one or more frequency control words to said DDFS to control said generation of said first signal.

4. The method according to claim 1, comprising mixing said first signal and said received RF signal to generate said frequency translated RF signal.

5. The method according to claim 4, comprising bandpass filtering said frequency translated RF signal to select one of: an upper sideband and a lower sideband of said frequency translated RF signal.

6. The method according to claim 1, wherein said first signal comprises an in-phase (I) component and a quadrature (Q) component.

7. The method according to claim 6, comprising:
phase shifting said received RF signal to generate in-phase (I) and quadrature components (Q) of said received RF signal;
mixing, via a plurality of mixers, said I and Q components of said received RF signal with said I and Q components of said first signal; and
combining outputs of said plurality of mixers to generate said frequency translated RF signal, wherein said frequency translated signal comprises one of: an upper sideband and a lower sideband.

8. The method according to claim 7, comprising inverting a signal output by one of said plurality of mixers to select a different sideband for transmission.

9. The method according to claim 6, comprising:
mixing, via a plurality of mixers, said received RF signal with said I and Q components of said first signal;
phase shifting an output signal of a first of said plurality of mixers; and
combining said phase shifted signal with an output signal of a second of said plurality of mixers to generate said frequency translated RF signal, wherein said frequency translated signal comprises one of: an upper sideband and a lower sideband.

10. The method according to claim 9, comprising inverting a signal output by said first of said plurality of mixers to select a different sideband for transmission.

11. A system for wireless communication, the system comprising:
one or more circuits comprising a direct digital frequency synthesizer (DDFS), wherein said one or more circuits enable generation of a first signal;
said one or more circuits enable frequency translating a received RF signal using said first signal; and
said one or more circuits enable transmission of said frequency translated RF signal.

12. The system according to claim 11, wherein said first signal is based on a local oscillator signal.

13. The system according to claim 11, wherein said one or more circuits comprise one or more processors that communicate one or more frequency control words to said DDFS to control said generation of said first signal.

14. The system according to claim 11, wherein said one or more circuits comprise a mixer that mixes said first signal and said received RF signal to generate said frequency translated RF signal.

15. The system according to claim 14, wherein said one or more circuits comprise a bandpass filter that bandpass filters said frequency translated RF signal to select one of: an upper sideband and a lower sideband of said frequency translated RF signal.

16. The system according to claim 11, wherein said first signal comprises an in-phase (I) component and a quadrature (Q) component.

17. The system according to claim 16, wherein:
said one or more circuits comprise a phase shifter that phase shifts said received RF signal to generate in-phase (I) and quadrature components (Q) of said received RF signal;
said one or more circuits comprise a plurality of mixers that mixes said I and Q components of said received RF signal with said I and Q components of said first signal; and
said one or more circuits combines outputs of said plurality of mixers to generate said frequency translated RF signal, wherein said frequency translated signal comprises one of: an upper sideband and a lower sideband.

18. The system according to claim 17, wherein said one or more circuits comprise one or more processors that control inverting a signal output by one of said plurality of mixers to select a different sideband for transmission.

19. The system according to claim 16, wherein:
said one or more circuits comprise a plurality of mixers that mixes said received RF signal with said I and Q components of said first signal;
said one or more circuits comprise a phase shifter that phase shifts an output signal of a first of said plurality of mixers; and
said one or more circuits combines said phase shifted signal with an output signal of a second of said plurality of mixers to generate said frequency translated RF signal, wherein said frequency translated signal comprises one of: an upper sideband and a lower sideband.

20. The system according to claim 19, wherein said one or more circuits comprise one or more processors that control inverting a signal output by said first of said plurality of mixers to select a different sideband for transmission.
